(19) United States
(12) Patent Application Publication
(10) Pub. No.: US 2023/0205168 A1
(43) Pub. Date: Jun. 29, 2023

(54) Methods of Optimizing Pump Performance

(71) Applicant: Performance Multi-Flow Solutions, LLC, Midland, TX (US)

(72) Inventors: George Allan Martinez, Midland, TX (US); Brian Anthony Sevin, Midland, TX (US)

(21) Appl. No.: 17/565,012

(22) Filed: Dec. 29, 2021

(51) Int. Cl. G05B 19/406

(52) U.S. Cl. CPC G05B 19/406; G05B 2219/37371

(57) ABSTRACT

A method of optimizing pump performance includes providing a measurement device on a pump equipment assembly, gathering a data reading from the measurement device during operation of the pump equipment assembly, evaluating the data reading, and determining whether remedial action needs to be taken to improve the performance of the pump equipment assembly based on the evaluation.

### TECHNICAL FIELD

The present disclosure relates generally to methods for determining pump health and overall performance from measured operational data to mitigate undesirable operating conditions, reduce failures, reduce downtime, enhance efficiency, and reduce power costs.

### BACKGROUND

Pump equipment may be used in many different types of industrial settings to transfer fluids (liquids, gases, and combinations thereof) from one location to another. In some industrial settings, pump equipment may be exposed to harsh operating conditions, such as extreme temperatures; high pressures; variable flow rates; heavy vibrations; fluids that are viscous, corrosive, or entrained with abrasive solids; and/or other conditions that can increase the likelihood of a decline in pump equipment performance and efficiency.

### SUMMARY

In one aspect, the present disclosure is directed to a method of determining pump equipment performance by comparing actual operational data measurements to ideal operational data values.

In another aspect, the present disclosure is directed to a method of determining pump equipment performance by comparing current operational data measurements to historical operational data measurements to identify trends indicating declining pump equipment performance.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 depicts a schematic view of one representative operational environment in which pump equipment may be used according to the present disclosure.

FIG. 2 depicts a side perspective view of one implementation of a pump equipment assembly equipped with various measurement devices according to the present disclosure.

FIG. 3 depicts representative pump curve graphs of discharge pressure versus flow rate for one implementation of a surface pump equipped with a variable frequency drive (VFD) according to the present disclosure.

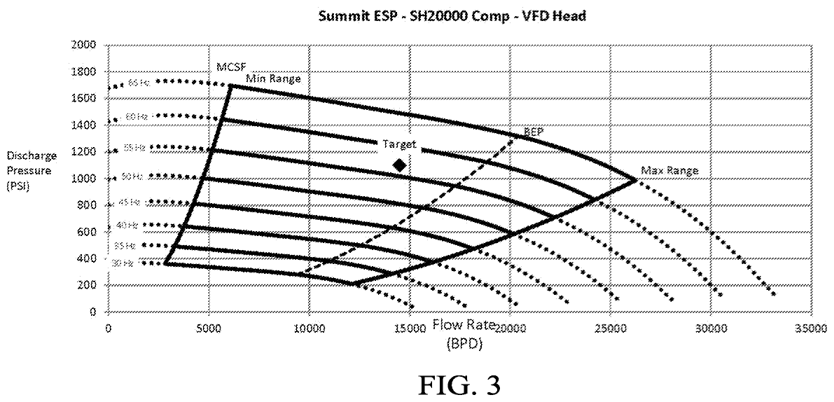

FIG. 4 depicts representative power curve graphs of horsepower versus flow rate for one implementation of a surface pump equipped with a variable frequency drive (VFD) according to the present disclosure.

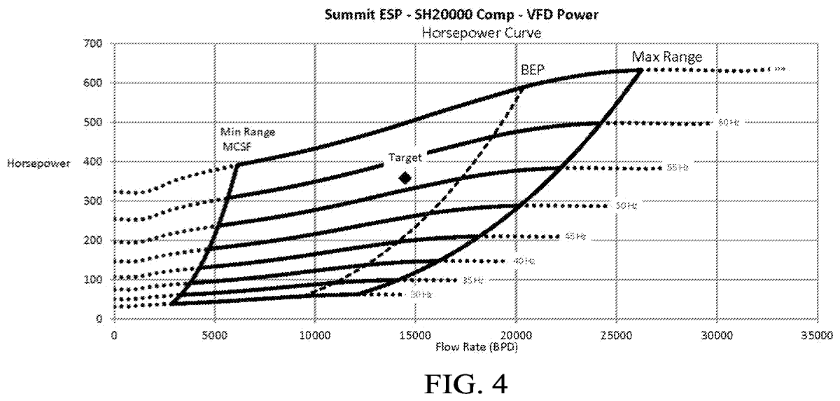

FIG. 5 depicts a representative Net Positive Suction Head Required (NPSHr) curve in feet of head versus flow rate for one implementation of a surface pump operating at 3570 revolutions per minute (rpm) according to the present disclosure.

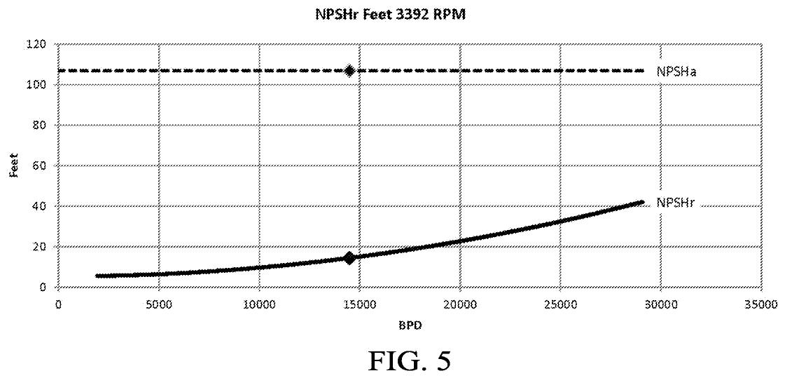

Like reference symbols in the various drawings indicate like elements.

### DETAILED DESCRIPTION

Implementations of the present disclosure are directed to methods of determining pump equipment performance by capturing measured operational data, either in real time or periodically, and performing an analysis on that measured operational data. In some implementations, the analysis is based on a comparison between the measured operational data and an ideal measurement or an ideal range of measurements. In some implementations, the analysis is based on a comparison between the current measured operational data and historical measured operational data to identify trends that indicate negative performance and/or a decline in the health of the pump equipment.

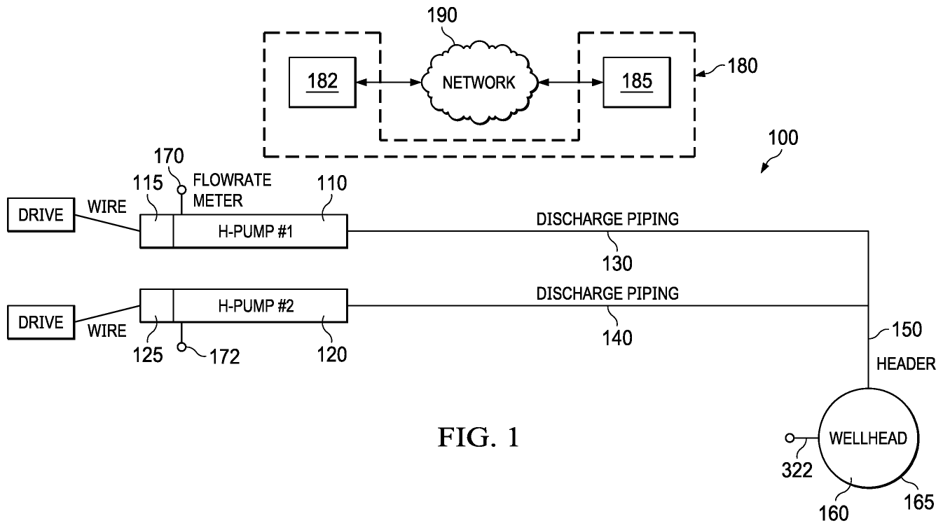

FIG. 1 schematically depicts one implementation of a representative operational environment 100 in which one or more pumps 110, 120, each driven by motors 115, 125, may pump fluid through separate discharge piping 130, 140 and into a common header 150 that routes the fluid to a wellhead 160 leading into a well bore 165. In some implementations, meters 170, 172 may be coupled to the intake flanges of each pump 110, 120 to measure a flowrate of fluid flowing into the respective pumps 110, 120.

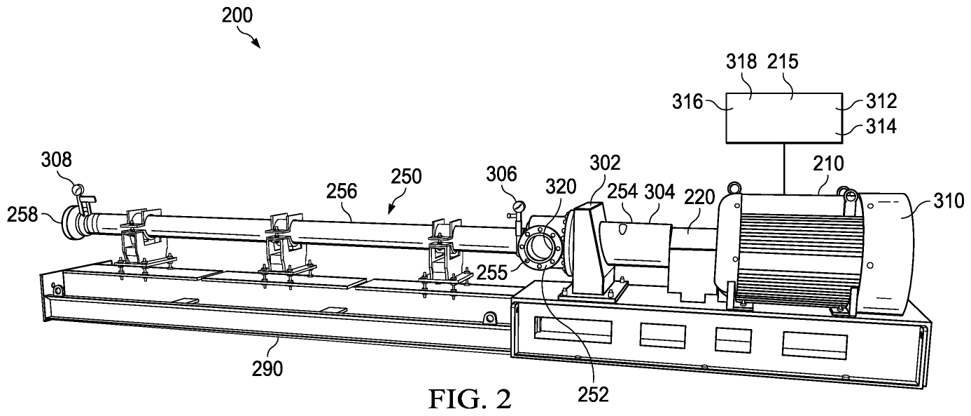

FIG. 2 depicts a side perspective view of one implementation of a pump equipment assembly 200 equipped with various measurement devices according to the present disclosure. In more detail, the pump equipment assembly 200 comprises a pump skid 290 that supports a motor 210 coupled to a pump 250 via a motor coupling 220. In some implementations, the motor 210 is operated through a controller or drive 215, such as a variable frequency drive (VFD), for example. The pump 250 comprises an intake flange 252, a thrust chamber 254, a mechanical seal 255, a pump element 256, and a discharge flange 258.

In operation, fluid flows into the pump 250 through the intake flange 252, and the thrust chamber 254 transfers torque from the motor 210 to the pump element 256, while absorbing thrust loads generated by the pump 250 and securely mounting the mechanical seal 255 that keeps pumped fluid from escaping the pump 250. The pumped fluid exits the pump element 256 through the discharge flange 258.

With continued reference to FIG. 2, various measurement devices 300 may be provided on the pump equipment assembly 200 to measure operational data. In some implementations, a thrust chamber vibration transmitter 302 and/or a thrust chamber temperature transmitter 304 may be coupled to the thrust chamber 254 to measure vibration and/or temperature, respectively. Pressure transmitters 306, 308 may be provided on the intake flange 252 and/or the discharge flange 258, respectively. A motor temperature transmitter, also referred to as a resistance temperature detector (RTD), 310 may be provided inside the motor 210. A motor ammeter device 312, a motor input voltmeter 314, a motor output voltmeter 316, and/or a motor frequency meter 318 may be positioned inside the motor controller/drive 215. In some implementations, a flow meter 320 may be coupled to the intake flange 252 to measure a flowrate of fluid flowing into the pump 250.

Referring now to FIG. 1, additional measurement devices may be provided at other locations in the operational environment 100, such as a pressure transmitter 322 at the wellhead 160. In some implementations, the measured operational data from all the measurement devices 300 is received by a computer-based system 180, such as a Supervisory Control and Data Acquisition (SCADA) system, that monitors and controls the equipment in the operational environment 100, which may include a pump equipment assembly, such as the pump equipment assembly 200 of FIG. 2. In some implementations, the computer-based system 180 gathers the readings of measured operational data from the various measurement devices 300 via a local computer 182 in the operational environment 100. In some implementations, the computer-based system 180 transmits the measured operational data, either periodically or in real time, via a wired or wireless network 190 to a central computer 185 that may be remote from the operational environment 100. In some implementations, the central computer 185 is operable to perform the evaluation and analysis employed by the methods of the present disclosure.

In some implementations, the computer-based system 180 gathers one or more of the measured operational data listed in Table 1 from the various measurement devices 300:

TABLE 1

| | Representative | Representative |
|---|---|---|
| Measured Operational Data | Unit of Measure | Measurement Device |
| Frequency | Hertz (Hz) | Motor frequency meter 318 |
| Intake Pressure | Pounds per square inch (PSI) | Pressure transmitter 306 |
| Discharge Pressure | PSI | Pressure transmitter 308 |
| Wellhead Pressure | PSI | Pressure transmitter 322 |
| Flowrate | Barrels per day (BPD) | Flow meter 170, 172, 320 |
| Drive Amperage | Amperage (Amps) | Motor ammeter device 312 |
| Thrust Chamber Vibration | Inches per second (IPS) | Vibration transmitter 302 |
| Thrust Chamber Temperature | Degrees Fahrenheit (° F.) | Temperature transmitter 304 |
| Input Voltage | Volts | Motor input voltmeter 314 |
| Output Voltage | Volts | Motor output voltmeter 316 |

The computer-based system 180 may gather readings of the measured operational data via the local computer 182 in real time or periodically. In some implementations, the readings of the measured operational data may be saved to a memory of the local computer 182 to create historical data, or the readings of the measured operational data may be transmitted, either periodically or in real time, via network 190 to the central computer 185 and then saved to a memory of the central computer 185 to create historical data.

In some implementations, the central computer 185 performs evaluations and analyses on the readings of the measured operational data either periodically or in real time. In one implementation, the evaluations and analyses according to the methods of the present disclosure comprise comparing one or more of the actual measured operational data readings against ideal readings or ranges of readings for that operational data. In some implementations, the ideal readings or ranges of readings are determined as indicated in Table 2.

TABLE 2

| Operational Data | Representative Ideal Readings or Ranges of Readings |
|---|---|
| Frequency | Ideal is set for each pump based on the pump curve and the |
| | pump operating window. A representative ideal frequency |
| | range is 30 Hz to 60 Hz. |
| Intake Pressure | Ideal is set for each pump based on the Net Positive Suction |
| | Head required (NPSHr) for the specific pump curve. |
| Discharge Pressure | Ideal is set for each pump based on the following formula: |
| | (Actual Frequency/60 Hz) x Best Efficiency Point (BEP) |
| | discharge pressure of the pump. |
| Wellhead Pressure | Ideal is equal to the actual Discharge Pressure. This data is |
| | used to confirm there is not a large variance between the |
| | actual Wellhead Pressure and the actual Discharge |
| | Pressure. The variance indicates some inefficiencies of |
| | operation. |
| Flowrate | Ideal is set for each pump based on the following formula: |
| | (Actual Frequency/60 Hz) × Best Efficiency Point (BEP) |
| | flowrate of the pump. |
| Drive Amperage | Ideal is set for each motor based on the following |
| | formula: |
| | (Actual Frequency/60 Hz) x Motor Nameplate amperage x |
| | specific gravity of water. |
| Thrust Chamber Vibration | Ideal is set for the thrust chamber vibration to be below |
| | 0.2 IPS. |
| Thrust Chamber Temperature | Ideal is set for each pump based on the manufacturer |
| | recommended optimal thrust chamber temperature. |
| Input Voltage | Ideal is set based on the size of the motor. Representative |
| | ideal input voltages are either 480 volts or 4160 volts. |
| Output Voltage | This reading is tracked and monitored but no ideal reading |
| | is set for this parameter. |

In one implementation, the evaluations and analyses according to the methods of the present disclosure comprise calculating the percent difference between the actual measured operational data readings and the ideal readings or ranges of readings for that operational data. The magnitude of the percent difference is an indication of how well the pump is performing and whether remedial action needs to be taken.

In other implementations, the methods of the present disclosure comprise performing an evaluation of the actual measured operational data reading against the ideal readings or ranges of readings for that operational data and then grading the actual reading to determine whether remedial action needs to be taken. In some implementations, the grading is performed as indicated in Table 3.

TABLE 3

| Operational Data | Representative Grading of Actual Reading Compared |
|---|---|
| | to Ideal Readings or Ranges of Readings |
| Frequency | Evaluated as in or out of range. If the actual frequency |
| | reading is between the low limit (such as 30 Hz) and the |
| | high limit (such as 60 Hz), this reading is meeting all |
| | expectations. |
| Intake Pressure | Evaluated as in or out of range. If the actual intake pressure |
| | reading is above the NPSHr of the pump of 20 PSI, this |
| | reading is meeting all expectations. |
| Discharge Pressure | Evaluated based on acceptable optimal ranges and can vary |
| | by pump type or application. Representative ranges are: |
| | If the actual discharge pressure reading falls between 90% |
| | of minimum and 90% of maximum lines on the pump |
| | curve, this reading is meeting all expectations. |
| | If the actual discharge pressure reading falls between 90% |
| | of the minimum and up to the minimum points on the pump |
| | curve, or between 90% of the maximum and up to the |
| | maximum points on the pump curve, this reading enters a |
| | warning stage. |
| | If the actual discharge pressure reading is outside of the |
| | minimum and maximum points on the pump curve, this |
| | reading enters an alarm stage. |
| Flowrate | Evaluated based on acceptable optimal ranges and can vary |
| | by pump type or application. Representative ranges are: |
| | If the actual flowrate reading falls between 90% of |
| | minimum and 90% of maximum lines on the pump curve, |
| | this reading is meeting all expectations. |
| | If the actual flowrate reading falls between 90% of the |
| | minimum and up to the minimum points on the pump |
| | curve, or between 90% of the maximum and up to the |
| | maximum points on the pump curve, this reading enters a |
| | warning stage. |
| | If the actual flowrate reading is outside of the minimum and |
| | maximum points on the pump curve, this reading enters an |
| | alarm stage. |
| Drive Amperage | Evaluated based on acceptable optimal ranges and can vary |
| | by motor type or application. Representative ranges are: |
| | If the actual drive amperage reading is less than 90% of the |
| | motor nameplate, this reading is meeting all expectations. |
| | If the actual drive amperage reading falls between 90% and |
| | 99% of the motor nameplate, this reading enters a warning |
| | stage. |
| | If the actual drive amperage reading is 100% or more of the |
| | motor nameplate, this reading enters an alarm stage. |
| Thrust Chamber Vibration | Representative ranges are: |
| | If the actual thrust chamber vibration reading is less than |
| | 0.2 IPS, this reading is meeting all expectations. |
| | If the actual thrust chamber vibration reading is in the range |
| | 0.2 IPS to 0.25 IPS, this reading enters a warning stage. |
| | If the actual thrust chamber vibration reading is above 0.25 |
| | IPS, this reading enters an alarm stage. |
| Thrust Chamber Temperature | Evaluated based on acceptable temperature ratings |
| | according to manufacturer specifications. Representative |
| | ranges are: |
| | If the actual thrust chamber temperature reading is less than |
| | 90% of manufacturer specifications, this reading is meeting |
| | all expectations. |
| | If the actual thrust chamber temperature reading falls |
| | between 90% and 100% of manufacturer specifications, |
| | this reading enters a warning stage. |
| | If the actual thrust chamber temperature reading is 100% or |
| | above manufacturer specifications, this reading enters an |
| | alarm stage. |
| Input Voltage | This reading is tracked and monitored but not evaluated. |
| Output Voltage | This reading is tracked and monitored but not evaluated. |

In another implementation, the evaluations and analyses according to the methods of the present disclosure comprise graphing current measured operational data readings, historical measured operational data readings, and/or operational calculations and other information, and looking for trends indicating declining pump equipment performance and/or declining overall health of the pump equipment. The current and historical operating data readings that may be trended over time include any or all of the measured operational data presented in Table 1, as well as other data readings. In one implementation, the operational calculations that may be trended over time include a power cost per pump, which may be calculated as follows:

$$Power Cost = \frac{( Drive Amperage \times Input Voltage \times 1.732 \times 0.9 Power Factor )}{1000} \times Cost / Kilowatt$$

In some implementations, the methods of the present disclosure may be used to identify potential operational problems, and suggest possible solutions for such problems. Representative examples of identified potential operational problems and possible solutions for such problems are outlined in Table 4.

TABLE 4

| Identified Potential | |
|---|---|
| Operating Problem | Indications and Possible Solutions |
| Large variance between | This indicates unnecessary pressure buildup that can result |
| Discharge Pressure Reading | in higher power costs and lower flowrates to the well. |
| and Wellhead Pressure | Look for presence of back pressure valve or any natural |
| Reading | restrictions by reviewing facility pictures or calling the |
| | operator. Once restrictions are identified, have service |
| | technicians remove or reduce restrictions to optimal. |
| Flowrate Reading is out of | This indicates a problem with the pump or the flow meter. |
| Range | Reference the pump curve, convert brake horsepower to |
| | amperage, and compare the conversion to the expected |
| | amperage at the measured flowrate. Look for variance to |
| | establish a real problem with the pump and absolve flow |
| | meter issue. Once flow meter is verified, look for |
| | indications of pump wear or scale. This could result in an |
| | acid job or pump replacement to resolve the issue. |
| High Thrust Chamber | If the thrust chamber vibration is out of acceptable range, |
| Vibration | this indicates a number of potential problems, including |
| | misalignment of the pump, motor, or skid; pump |
| | operating outside of normal operating range; low |
| | lubricating fluids; excessive pump wear; or thrust |
| | chamber bearing failure. Have a service technician |
| | evaluate the vibration and determine the cause of the |
| | problem. This could result in a realignment of the system |
| | being required to resolve the issue. |

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
providing a measurement device on a pump equipment assembly;
gathering a data reading from the measurement device during operation of the pump equipment assembly;
evaluating the data reading; and
determining whether remedial action needs to be taken to improve the performance of the pump equipment assembly based on the evaluation.

2. The method of claim 1, wherein the evaluating step comprises:
comparing the data reading to an ideal reading or to an ideal range of readings.

3. The method of claim 2, wherein the ideal reading or the ideal range of readings is determined based on a pump curve.

4. The method of claim 2, wherein the ideal reading or the ideal range of readings is determined based on manufacturer specifications.

5. The method of claim 2, wherein the evaluating step further comprises:
calculating the percent difference between the data reading and the ideal reading or the ideal range of readings.

6. The method of claim 5, wherein the determining step comprises:
deciding whether remedial action needs to be taken based on a magnitude of the calculated percent difference.

7. The method of claim 2, wherein the evaluating step further comprises:
grading the data reading based on the comparison.

8. The method of claim 7, wherein the determining step comprises:
deciding whether remedial action needs to be taken based on the grade.

9. The method of claim 7, wherein the grading comprises confirming that the data reading meets expectations, or is in a warning stage, or is in an alarm stage.

10. The method of claim 1, wherein the evaluating step comprises:
comparing the data reading to a historical measured data reading; and
identifying whether the pump equipment assembly is declining in performance based on the comparison.

11. The method of claim 1, wherein the evaluating step comprises:
using the data reading to calculate a power cost associated with operation of the pump equipment assembly.

12. The method of claim 1, further comprising:
identifying an operational problem with the pump equipment assembly based on the evaluation; and
taking remedial action to resolve the identified operational problem.

13. The method of claim 1, wherein providing the measurement device on the pump equipment assembly comprises providing one of the following: a frequency meter, a pressure transmitter, a temperature transmitter, a flow meter, an ammeter device, and a vibration transmitter.

14. The method of claim 1, wherein gathering the data reading from the measurement device comprises gathering one of the following: a motor frequency, a pump intake pressure, a pump discharge pressure, a flowrate, a motor amperage, a thrust chamber vibration, and a thrust chamber temperature.

15. The method of claim 1, further comprising:
providing a pressure transmitter on a wellhead in operational communication with the pump equipment assembly; and
gathering a second data reading from the pressure transmitter on the wellhead during operation of the pump equipment assembly.

16. The method of claim 15, wherein the evaluating step comprises:
calculating a difference between the data reading and the second data reading.

17. The method of claim 16, wherein the determining step comprises:
deciding whether remedial action needs to be taken based on a magnitude of the calculated difference.
